(19) United States
(12) Patent Application Publication
(10) Pub. No.: US 2007/0049718 A1
(43) Pub. Date: Mar. 1, 2007

(54) Method for producing phosphonate-modified silicones

(75) Inventors: Oliver Schafer, Burghausen (DE); Hans-Joachim Luckas, Munich (DE); Sandra Rachl, Munich (DE)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, Munich (DE)

(21) Appl. No.: 10/595,035

(22) PCT Filed: Jul. 1, 2004
(86) PCT No.: PCT/EP04/07173

§ 371 Date: Jan. 9, 2006

(30) Foreign Application Priority Data
Jul. 10, 2003 (DE) 103312889
Jul. 10, 2003 (DE) 103 31 288.9

(51) Int. Cl. C08G 77/22

(52) U.S. Cl. 528/30

(57) ABSTRACT

Phosphonate-functional organosilicon compounds in which the phosphonate ester group is linked to silicon by an Si—C—P linkage are prepared rapidly and in high yield by the hydrolysis and polycondensation of phosphonate-functional alkoxysilanes with water.

The invention relates to a process for preparing phosphonate-modified organosilicon compounds by reacting silanes containing phosphonate groups with reactive silicon compounds.

Phosphonate-modified silicones are of great economic interest for a multitude of sectors. For example, they may be used as lubricants on metals and textiles, flame-retardant additives, adhesion promoters, additives for cosmetics or detergents, defoamers, mold-release agents, damping fluids, heat transfer fluids, antistatic agents or for polishes and coatings.

Phosphorus-modified siloxanes are prepared generally by reaction of trialkyl phosphites with chloropropyl-modified siloxanes, as described, for example, in Gallagher et al., J. Polym. Sci. Part A, Vol. 41, 48-59 (2003). Unfortunately, long reaction times and high temperatures are required in this reaction, which lead to rearrangements in the product and thus to yield losses and also undesired by-products.

The reaction of trialkyl phosphites with chloromethyl-modified siloxanes, as described in the U.S. Pat. No. 2,768,193 or by Gallagher et al., proceeds distinctly more rapidly, but has the disadvantage that the thus prepared siloxanes can be purified by distillation only with difficulty owing to their high boiling point. However, this reaction also proceeds slowly since the concentration of the reactive groups is greatly reduced by dilution with unreactive dimethylsiloxy units, which results in reaction times in the region of several hours.

It is thus an object of the present invention to provide a process for preparing phosphonate-modified organosiloxanes, by which, starting from commercially available chemicals, the phosphonate-modified organosiloxanes can be prepared in a very simple manner, with short reaction times and in high yields.

The invention provides a process for preparing phosphonate-modified organosiloxanes of the general formula (I):
(SiO_{4/2})ₖ(RSiO_{3/2})ₘ(R₂SiO_{2/2})ₚ(R₃SiO_{1/2})_{q}[O_{1/2}H]ₜ[(O_{f/2}R¹_{3-f}SiCR²₂P(O)(OR⁴)₂]ₛ (I)
in which
R is a hydrogen atom or a monovalent, optionally —CN—, —NCO—, —NR⁵₂—, —COOH—, —COOR⁵—, -halogen-, -acryloyl-, -epoxy-, —SH—, —OH— or —CONR⁵₂—substituted Si—C-bonded C₁-C₂₀-hydrocarbyl radical or C₁-C₁₅-hydrocarboxy radical in which one or more nonadjacent methylene units in each case may be replaced by —O—, —CO—, —COO—, —OCO—, —OCOO—, —S— or —NR⁵— groups and in each of which one or more nonadjacent methine units may be replaced by —N═, —N═N— or —P═ groups,
R¹ is a hydrogen atom or a monovalent, optionally —CN—, —NCO—, —COOH—, —COOR⁵—, -halogen-, -acryloyl-, —SH—, —OH— or —CONR⁵₂-substituted Si—C-bonded C₁-C₂₀-hydrocarbyl radical or C₁-C₁₅-hydrocarboxy radical in which one or more nonadjacent methylene units in each case may be replaced by —O—, —CO—, —COO—, —OCO—, —OCOO—, —S— or —NR⁵— groups and in each of which one or more nonadjacent methine units may be replaced by —N═, —N═N— or —P═ groups,
R² is hydrogen or an optionally —CN— or halogen-substituted C₁-C₂₀-hydrocarbyl radical,
R⁴ is an optionally —CN— or halogen-substituted C₁-C₂₀-hydrocarbyl radical or hydrocarboxy radical, or substituted or unsubstituted polyalkylene oxides having from 1 to 4000 carbon atoms,
R⁵ is hydrogen or an optionally —CN— or halogen-substituted C₁-C₁₀-hydrocarbyl radical,
k is an integer from 0 to 100 000,
m is an integer from 0 to 100 000,
p is an integer from 0 to 100 000,
q is an integer from 0 to 100 000,
f is an integer of 1, 2 or 3,
s is an integer of at least 1 and
t is an integer of at least 0,
   where
   k+m+p+q is an integer of at least 1,
   characterized in that
   functional silanes of the formula (III):
   [(R³O)_{f}R¹_{3-f}SiCR²₂P(O)(OR⁴)₂]
   are reacted with water alone or together with silanes of the general formula (IV):
   [(R³O)_{g}R¹_{4-g}Si]
   where
R³ is hydrogen or an optionally —CN— or halogen-substituted C₁-C₂₀-hydrocarbyl radical and
g is an integer of 1, 2, 3 or 4 and
R, R¹, R², R⁴, k, m, p, q, f and s are each as defined above.

The phosphonate-modified organosiloxanes of the general formula I have a phosphonate function which is bonded via a carbon atom by an Si—C—P bond to a silicon atom of the silicone compound.

The R radicals may be the same or different, substituted or unsubstituted, aliphatically saturated or unsaturated, aromatic, cyclic, straight-chain or branched. R preferably has from 1 to 12 atoms, in particular from 1 to 6 atoms, preferably only carbon and hydrogen atoms. R is preferably a straight-chain or branched C₁-C₆-alkyl radical. Particular preference is given to the methyl, ethyl, phenyl, vinyl and trifluoropropyl radicals.

The R¹ radicals may be the same or different, substituted or unsubstituted, aliphatically saturated or unsaturated, aromatic, cyclic, straight-chain or branched. R¹ is preferably a C₁-C₁₀-alkyl radical or phenyl radical, in particular branched or unbranched C₁-C₃-alkyl radical which may be substituted. R¹ is preferably a methyl radical or ethyl radical.

The R² radicals may each independently likewise be substituted or unsubstituted, aliphatically saturated or unsaturated, aromatic, cyclic, straight-chain or branched. R² is preferably a C₁-C₃-alkyl radical or hydrogen. R² is more preferably hydrogen.

The R³ radicals may each independently likewise be substituted or unsubstituted, aliphatically saturated or unsaturated, aromatic, cyclic, straight-chain or branched. R³ is preferably a C₁-C₅-alkyl radical, in particular C₁-C₃-alkyl radical, or hydrogen. R³ is more preferably a methyl or ethyl radical.

The R⁴ radicals may each independently likewise be substituted or unsubstituted, aliphatically saturated or unsaturated, aromatic, cyclic, straight-chain or branched. R⁴ is preferably a C₁-C₁₂-alkyl or aryl radical. R⁴ is more preferably a methyl, ethyl, butyl, phenyl or cyclohexyl radical. R⁴ may optionally also contain heteroatoms, for example oxygen or nitrogen, or other functional groups.

The R⁵ radicals are preferably hydrogen or a substituted C₁-C₅-alkyl radical.

p is preferably from 3 to 1000, in particular from 5 to 500.

k and m are preferably each independently an integer of from at least 0 to 1000, in particular 0.

q is preferably an integer of at least 1.

k+m is preferably 0, i.e. the organosiloxanes are linear. q is preferably 1 or 2.

s is preferably from 1 to 50, in particular from 2 to 10.

t is preferably from 0 to 10, in particular 0, 1 or 2.

k+m+p+q is preferably an integer of at least 2, in particular at least 3.

The alkoxysilanes of the general formula (III) used may be prepared in a simple manner and in high yields by reacting the corresponding chloroalkyl(alkoxy)silanes with trialkyl phosphites, as described, for example, in the U.S. Pat. No. 2,768,193.

For example, alkoxysilanes of the general formula (III) are selected from the group comprising H₃COSi(CH₃)₂CH₂PO(OC₂H₅)₂, (H₃CO)₂Si(CH₃)CH₂PO(OC₂H₅)₂, (H₃CO)₃SiCH₂PO(OC₂H₅)₂, (H₅C₂O)Si(CH₃)₂CH₂PO(OC₂H₅)₂, (H₅C₂O)₂Si(CH₃)CH₂PO(OC₂H₅)₂, (H₅C₂O)₃SiCH₂PO(OC₂H₅)₂, H₃COSi(CH₃)₂CH₂PO(OCH₃)₂, (H₃CO)₂Si(CH₃)CH₂PO(OCH₃)₂, (H₃CO)₃SiCH₂PO(OCH₃)₂, (H₅C₂O)Si(CH₃)₂CH₂PO(OCH₃)₂, (H₅C₂O)₂Si(CH₃)CH₂PO(OCH₃)₂ or (H₅C₂O)₃SiCH₂PO(OCH₃)₂.

The alkoxysilanes of the general formula (III) react either alone or together with silanes of the general formula (IV) with water to give Si—OH-functional compounds which subsequently condense with one another, for example, to give organosiloxanes or organosiloxane resins. It is possible to dispense with the use of specific catalysts. However, the reaction also proceeds with use of catalysts which are used in the prior art to accelerate the reaction of alkoxysilanes, for example in RTC-1 materials. However, it is possible if required to use other catalysts, for example phosphoric acids, or to change the pH.

This hydrolysis or condensation reaction, depending on the conditions, affords cyclic, linear, branched or crosslinked products which exhibit solubilities in different solvents depending on the content of phosphonic acid groups. Some of these compounds are even water-soluble.

The process is carried out preferably at from 0 to 100° C., more preferably at from 10 to 80° C.

The process may be carried out either with inclusion of solvents or else without the use of solvents in suitable reactors. It is possible if appropriate to work under reduced pressure or under elevated pressure or at standard pressure (0.1 MPa). The resulting alcohol may then be removed from the reaction mixture under reduced pressure at room temperature or at elevated temperature.

When solvents are used, preference is given to inert, especially aprotic solvents such as aliphatic hydrocarbons, for example heptane or decane, and aromatic hydrocarbons, for example toluene or xylene. It is likewise possible to use ethers such as tetrahydrofuran (THF), diethyl ether, tert-butyl methyl ether (MTBE) or ketones such as acetone or 2-butanone (MEK). The type and amount of the solvent should be sufficient to ensure sufficient homogenization of the reaction mixture. Preference is given to solvents or solvent mixtures having a boiling point or boiling range of up to 120° C. at 0.1 MPa.

All of the above symbols of the above formulae are each defined independently of one another.

In the examples which follow, unless stated otherwise, all amounts and percentages are based on the weight, all pressures are 0.10 MPa (abs.) and all temperatures are 20° C.

The invention is illustrated by the examples which follow.

### EXAMPLE 1

### Noninventive

A 250 ml three-neck flask flask with dropping funnel and reflux condenser was initially charged under a nitrogen atmosphere with 99.7 g (0.6 mol) of triethyl phosphite (P(OEt)₃, Aldrich, GC 98%). After heating to 140° C., 46.4 g of chloromethyldimethoxymethylsilane (0.3 mol) (Wacker-Chemie GmbH, Munich) were slowly added dropwise with vigorous stirring within 3 hours. Subsequently, the reaction mixture was heated to 170° C. for another 30 min. After the excess triethyl phosphite had been removed under reduced pressure, 58.6 g of diethoxyphosphorous ester methyldimethoxymethylsilane (0.23 mol, GC 98%, yield: 76% of theory) were distilled off at a temperature of 133° C. and a vacuum of 12 mbar.

### EXAMPLE 2

### Noninventive

A 250 ml three-neck flask flask with dropping funnel and reflux condenser was initially charged under a nitrogen atmosphere with 124.5 g (0.75 mol) of triethyl phosphite (P(OEt)₃, Aldrich, GC 98%). After heating to 140° C., 69.3 g of chloromethyldimethylmethoxysilane (0.5 mol) (Wacker-Chemie GmbH, Munich) were slowly added dropwise with vigorous stirring within 2.5 hours. Subsequently, the reaction mixture was heated to 170° C. for another 30 min. After the excess triethyl phosphite had been removed under reduced pressure, 100.4 g of diethoxyphosphorous ester methyldimethylmethoxysilane (0.42 mol, GC 98.2%, yield: 83.6% of theory) were distilled off at a temperature of 118-122° C. and a vacuum of 11 mbar.

### EXAMPLE 3

### Noninventive

A 250 ml three-neck flask flask with dropping funnel and reflux condenser was initially charged under a nitrogen atmosphere with 112.2 g (0.675 mol) of triethyl phosphite (P(OEt)₃, Aldrich, GC 98%). After heating to 140° C., 76.8 g of chloromethyltrimethoxysilane (0.45 mol) (Wacker-Chemie GmbH, Munich) were slowly added dropwise with vigorous stirring within 2.5 hours. Subsequently, the reaction mixture was heated to 170° C. for another 30 min. After the excess triethyl phosphite had been removed under reduced pressure, 105.6 g of diethoxyphosphorous ester methyltrimethoxysilane (0.39 mol, GC 97.4%, yield: 86.2% of theory) were distilled off at a temperature of 135-138° C. and a vacuum of 12 mbar.

### EXAMPLE 4

### Noninventive

A 250 ml three-neck flask flask with dropping funnel and reflux condenser was initially charged under a nitrogen atmosphere with 99.7 g (0.6 mol) of triethyl phosphite (P(OEt)₃, Aldrich, GC 98%). After heating to 140° C., 85.1 g of chloromethyltriethoxysilane (0.4 mol) (Wacker-Chemie GmbH, Munich) were slowly added dropwise with vigorous stirring within 1.5 hours. Subsequently, the reaction mixture was heated to 170° C. for another 1.5 hours. After the excess triethyl phosphite had been removed under reduced pressure, 95.8 g of diethoxyphosphorous ester methyltriethoxysilane (0.31 mol, GC 98%, yield: 77.4% of theory) were distilled off at a temperature of 146° C. and a vacuum of 11-13 mbar.

### EXAMPLE 5

### Hydrolysis Of Dialkoxysilane

A 250 ml three-neck flask flask with dropping funnel and reflux condenser was initially charged under a nitrogen atmosphere with 58.6 g of diethoxyphosphorous ester methyldimethoxymethylsilane (0.23 mol, GC 98) from example 1. After heating to 60° C., 18 g of water (1.0 mol) were slowly added dropwise with vigorous stirring within 10 minutes. Subsequently, the reaction mixture was heated to 60° C. for another 120 minutes. After the alcohol formed and the excess water had been removed under reduced pressure, 38 g of poly((diethoxyphosphorous ester methyl)methylsiloxane) having an average molecular weight of 1200 g/mol were obtained, and mainly cyclic compounds were present according to ¹H NMR.

### EXAMPLE 6

In a 250 ml flask, 13.5 g (50 mmol) of diethoxyphosphorous ester methyltrimethoxysilane and 6 g of dimethyldimethoxysilane were dissolved in 150 ml of a water/acetone solution (50/50). Subsequently, the mixture was left to stand at room temperature for 3 days and the solvent mixture was then removed on a Rotavapor. 14.1 g of a homogeneous white powder were obtained, which were identifiable by GPC and NMR as a homogeneous silicone resin without linear siloxane fractions and having a molecular weight of approx. 3400 g/mol.

### EXAMPLE 7

In a 100 ml flask, 12 g of dimethoxydimethylsilane (100 mmol) and 25.6 g of diethoxyphosphorus ester methyldimethoxymethylsilane (100 mmol) were hydrolyzed with 14.5 g of water and 3% by weight of 37% HCl at 80° C. and 100 mbar with stirring for 2 hours. Subsequently, the excess water and the alcohol formed were removed under reduced pressure. According to NMR, 26.3 g of a copolymer having dimethylsiloxane and methyl/diethoxyphosphorous ester methyldimethoxymethylsiloxane groups were obtained. According to GPC, this polymer consisted to an extent of approx. 44% of a cyclic fraction having an average molar mass of approx. 650 g/mol and a linear fraction of approx. 56% and an average molar mass of approx. 6200 g/mol. At the given stoichiometry, this corresponds to a degree of polymerization of 4 for the cyclic fraction and a degree of polymerization of approx. 18 for the linear component.

### EXAMPLE 8

In a 100 ml flask, 6 g of dimethoxydimethylsilane (50 mmol) and 24.0 g of diethoxyphosphorous ester methyldimethylmethoxysilane (100 mmol) were hydrolyzed with 12 g of water and 3% by weight of 37% HCl at 80° C. and 100 mbar with stirring for 2 hours. Subsequently, the excess water and the alcohol formed were removed under reduced pressure. According to NMR, 24.1 g of a copolymer having dimethylsiloxane chain members and dimethyl/diethoxyphosphorous ester methyldimethoxymethylsiloxane end groups were obtained. According to GPC, this polymer had an average molar mass of 480 g/mol. At the given stoichiometry, this corresponds to the expected trimer A-B-A.

### EXAMPLE 9

In a 100 ml flask, 30 g of dimethoxydimethylsilane (250 mmol) and 24.0 g of diethoxyphosphorous ester methyldimethylmethoxysilane (100 mmol) were hydrolyzed with 40 g of water and 3% by weight of 37% HCl at 80° C. and 100 mbar with stirring for 3 hours. Subsequently, the excess water and the alcohol formed were removed under reduced pressure. According to NMR, 35.3 g of a copolymer having dimethylsiloxane chain members and dimethyl/diethoxyphosphorous ester methyldimethoxymethylsiloxane end groups were obtained. According to GPC, this polymer had an average molar mass of 810 g/mol.

### EXAMPLE 10

### Use as an Antistatic Additive

50 g of a commercial moisture-crosslinking silicone sealant from Wacker (Wacker Elastosil®) were mixed in a mixer with 5 g of a copolymer according to example 7 with exclusion of moisture. The material was spread out to form a plaque of thickness 3 mm and crosslinked over 3 days. The thus obtained specimen and a specimen without additive were stored at room temperature under ambient air over 4 weeks. The deposition of dust particles onto the surface was assessed visually after different time intervals (++=dust-free, +=noticeable dust attachment, 0=distinct dust attachment). The result is shown in table 1.

TABLE 1

| | RTC-1 with | RTC-1 without |
|---|---|---|
| | silicone additive | silicone additive |
| 1 week | ++ | ++ |
| 2 weeks | ++ | + |
| 4 weeks | ++ | 0 |

It was found that the additive according to example 7 has a distinctly reduced tendency to be soiled in comparison to the unmodified rubber.

1-10. (canceled)

11. A process for preparing phosphonate-modified organosiloxanes of the formula (I):
(SiO_{4/2})ₖ(RSiO_{3/2})ₘ(R₂SiO_{2/2})ₚ(R₃SiO_{1/2})_{q}[O_{1/2}H]ₜ[(O_{f/2}R¹_{3-f}SiCR²₂P(O)(OR⁴)₂]ₛ (I)
in which
R is a hydrogen atom or a monovalent, optionally —CN—, —NCO—, —NR⁵₂—, —COOH—, —COOR⁵—, -halogen-, -acryloyl-, -epoxy-, —SH—, —OH— or —CONR⁵₂-substituted Si—C-bonded C₁-C₂₀-hydrocarbyl or C₁-C₁₅-hydrocarbonoxy radical in which one or more nonadjacent methylene units in each case may be replaced by —O—, —CO—, —COO—, —OCO—, —OCOO—, —S— or —NR⁵— groups and in each of which one or more nonadjacent methine units may be replaced by —N═, —N═N— or —P═ groups,
R¹ is a hydrogen atom or a monovalent, optionally —CN—, —NCO—, —COOH—, —COOR⁵—, -halogen-, -acryloyl-, —SH—, —OH— or —CONR⁵₂-substituted Si—C-bonded C₁-C₂₀-hydrocarbyl or C₁-C₁₅-hydrocarbonoxy radical in which one or more nonadjacent methylene units in each case may be replaced by —O—, —CO—, —COO—, —OCO—, —OCOO—, —S— or —NR⁵— groups and in each of which one or more nonadjacent methine units may be replaced by —N═, —N═N— or —P═ groups,
R² is hydrogen or an optionally —CN— or halogen-substituted C₁-C₂₀-hydrocarbyl radical,
R⁴ is an optionally —CN— or halogen-substituted C₁-C₂₀-hydrocarbyl or hydrocarbonoxy radical,
R⁵ is hydrogen or an optionally —CN— or halogen-substituted C₁-C₁₀-hydrocarbyl radical or substituted or unsubstituted polyoxyalkylene radicals having from 1 to 4000 carbon atoms,
k is an integer from 0 to 100,000,
m is an integer from 0 to 100,000,
p is an integer from 0 to 100,000,
q is an integer from 0 to 100,000,
f is an integer of 1, 2 or 3,
s is an integer of at least 1 and
t is an integer of at least 0,
where
k+m+p+q is an integer of at least 1,
comprising:
reacting functional silanes of the formula (III):
[(R³O)_{f}R¹_{3-f}SiCR²₂P(O)(OR⁴)₂] (III)
with water, alone or together with silanes of the formula (IV):
[(R³O)_{g}R¹_{4-g}Si] (IV)
where
R³ is hydrogen or an optionally —CN-substituted or halogen-substituted C₁-C₂₀-hydrocarbyl radical and
g is an integer of 1, 2, 3 or 4 and
R, R¹, R², R⁴, k, m, p, q, f and s are each as defined above.

12. The process of claim 11, wherein alkoxysilanes of the formula (III) react with water to give Si—OH-functional compounds which condense further with one another to give cyclic, linear, branched or crosslinked organopolysiloxanes or organopolysiloxane resins.

13. The process of claim 11, wherein alkoxysilanes of the formula (III) react with silanes of the general formula (IV) and water to give Si—OH-functional compounds which condense further with one another to give cyclic, linear, branched or crosslinked organopolysiloxanes or organopolysiloxane resins.

14. The process of claim 12, wherein a catalyst is used.

15. The process of claim 14, wherein a catalyst is used.

16. The process of claim 11, wherein the process is carried out at from 10 to 80° C.

17. The process of claim 11, wherein at least one solvent selected from the group consisting of aliphatic hydrocarbons, heptane, decane, aromatic hydrocarbons, toluene, xylene, ether, tetrahydrofuran, diethyl ether, tert-butyl methyl ether, ketones, acetone, and 2-butanone is included in the reaction.

18. The process of claim 11, wherein no solvent is added.

19. The process of claim 11, wherein
R each, independently is a methyl, ethyl, vinyl or trifluoropropyl radical,
R¹ each, independently is a methyl or ethyl radical,
R² is hydrogen,
R³ each, independently is a methyl or ethyl radical,
R⁴ each, independently is a substituted or unsubstituted methyl, butyl, phenyl or cyclohexyl radical,
R⁵ each, independently is hydrogen or a substituted or unsubstituted C₁-C₅-alkyl radical,
k is 0,
m is 0,
p is an integer from 5 to 500,
q is 1 or 2,
f is an integer of 1, 2 or 3,
s is an integer of from 2 to 10, and
t is an integer of at least 0.

20. The process of claim 11, wherein the sum of k+m+p+q is an integer of at least 3.

21. An elastomer composition comprising as one component thereof, a phosphonate-modified organosiloxane prepared by the process of claim 11.

22. The elastomer composition of claim 21, wherein said phosphonate-modified organosiloxane is an antistatic additive.

23. A siloxane elastomer composition comprising as one component thereof, a phosphonate-modified organosiloxane prepared by the process of claim 11.

24. The siloxane elastomer composition of claim 21, wherein said phosphonate-modified organosiloxane is an antistatic additive.
